(19) United States
(12) Patent Application Publication
(10) Pub. No.: US 2021/0283956 A1
(43) Pub. Date: Sep. 16, 2021

(54) ADAPTER FOR MOUNTED ASSEMBLY, COMPRISING A REFERENCE LAYER

(71) Applicant: COMPAGNIE GENERALE DES ETABLISSEMENTS MICHELIN, CLERMONT-FERRAND (FR)

(72) Inventor: JOSÉ MERINO LOPEZ, CLERMONT-FERRAND (FR)

(21) Appl. No.: 16/317,995

(22) PCT Filed: Jul. 14, 2017
(86) PCT No.: PCT/IB2017/054264

§ 371 Date: Jan. 15, 2019

(30) Foreign Application Priority Data
Jul. 15, 2016 (FR) 1670383

(51) Int. Cl. B60C 15/02; B60B 25/04; B60B 25/08; B60B 25/12

(52) U.S. Cl. CPC B60C 15/0203; B60B 25/12; B60B 25/08; B60B 25/045

(57) ABSTRACT

In a rolling assembly comprising a tyre (P), an adapter (A) provides the connection between one of the beads (B) and the rim (J) of the rolling assembly, the adapter (A) comprising: a substantially axial body (11) comprising at least one main reinforcement (17) comprising one first (18) and one second (19) reinforcing ply each comprising reinforcers coated in elastomer composition referred to as skim rubber (31); a layer (30) of elastomer composition in a colour other than black, also referred to as coloured rubber, positioned as desired—in place of the skim rubber (31) with which the reinforcers of each ply are coated, or in place of the skim rubber (31) with which the reinforcers are coated and placed only on the exterior periphery of the reinforcing plies, or on the outside of the skim rubber (31).

### TECHNICAL FIELD OF THE INVENTION

The present invention relates to an adapter for a rolling assembly intended to be fitted to a passenger vehicle. Another subject of the invention is the said rolling assembly, made up of a tyre, a rim and two adapters providing the connection between the two beads of the tyre and the rim.

### PRIOR ART

Because a tyre is a toric structure having, as axis of revolution, its axis of rotation, it can be described in a radial plane passing through its axis of rotation. In what follows, for any radial plane, the radial, axial and circumferential directions denote the directions perpendicular to the axis of rotation of the tyre, parallel to the axis of rotation of the tyre and perpendicular to the radial plane, respectively. The equatorial plane designates the plane passing through the middle of the tread and perpendicular to the axis of rotation of the tyre. Any section through the tyre along a radial plane is referred to as a radial section. In general, a tyre comprises a tread, intended to come into contact with the ground, two sidewalls extending the axial ends of the tread radially inwards, and two beads extending the two sidewalls radially inwards and intended to come into contact with a rim.

Document WO 00/78565 proposes inserting an elastic adapter between a tyre bead and a rim. Such an adapter comprises, axially from the inside towards the outside, an axially inner end referred to as adapter bead, comprising an inner reinforcing element and intended to attach the adapter to the rim, an axially outer end comprising an outer reinforcing element and intended to accept a bead of a tyre, and a body connecting the two respectively axially inner and axially outer ends. The outer reinforcing element comprises a substantially radial first portion situated on the inside of the axially outer end, and a substantially axial second portion situated on the inside of the body, the first and second portions being substantially perpendicular to one another and forming a continuous assembly.

Such an adapter allows a tyre to be mounted on a rim that is narrower than the one recommended by the usual standards, such as, for example, the ETRTO (European Tyre and Rim Technical Organisation) standard. The rim, however, may conform to this standard.

Also known, from document FR2,491,836A1, is an adapter placed between the bead of a tyre and a rim and intended to solve the problems of assembling and of dismantling a tyre in relation to a rim. That adapter mainly comprises two annular bead wires that are spaced apart from one another and mounted inside an annular body comprising a ply. The bead wires are connected by a cord or by a set of parallel cords or a ply which, moreover, wraps around them.

A rolling assembly equipped with an adapter as described in the aforementioned documents performs the main functions of a conventional rolling assembly, in which the tyre is mounted directly on its recommended rim, and notably guarantees a drift thrust response when a drift angle is applied, namely when a rotation about a radial direction is applied, with enough flexibility to avoid any damage to the rolling assembly.

Document WO 2015091620 describes an adapter for a rolling assembly. This rolling assembly comprises a tyre having two beads, a rim, the said adapter providing the connection between one of the beads and the rim. The adapter comprises an axially inner end intended to be mounted on the rim seat. At least one main reinforcement provides the connection between an outer reinforcer and an inner reinforcer of the adapter. A substantially cylindrical adapter seat is intended to receive one of the said beads. The adapter described comprises no means that makes it possible to indicate potential damage.

Document WO 2009094803 describes a tyre comprising a layer acting as a wear indicator. This layer comprises a rubber compound, a coloured material, and a silicone-based anti-wear agent, which makes the composition particularly complex.

The inventors have noticed that adapters, because they are not generally in direct contact with the ground, generally have a longer life than the tyres mounted on them. Moreover, most tyre users or, failing that, vehicle-maintenance, and particularly tyre-maintenance, centres regularly have to check tyre wear. Tread wear indicators are provided for doing this. It is thus relatively easy to determine whether a tyre needs to be changed. Yet in contrast with this, adapters have no equivalent means of indicating to the user whether or not the adapter has reached the end of its life.

The invention provides various technical means for alleviating these various drawbacks.

### SUMMARY OF THE INVENTION

First of all, a first object of the invention is to provide an adapter that makes it possible to indicate to the user whether the life is reaching its end.

Another object of the invention is to provide an adapter that makes it possible to indicate to the user that damage liable to affect the structure has occurred and that an intervention is recommended.

In order to do this, the invention provides an adapter fora rolling assembly, the said rolling assembly having an axis of rotation and comprising a tyre (P) having two beads (B), a rim (J) having two rim bead seats, the said adapter (A) providing the connection between one of the beads (B) and the rim (J), the said adapter (A) comprising:
an axially inner end intended to be mounted on a rim bead seat and comprising an inner reinforcing element and a substantially radial axially outer face;
an axially outer end intended to come into contact with a bead (B) and comprising an outer reinforcing element and a substantially radial axially inner face or bearing face;
a substantially axial body connecting the said axially outer end to the said axially inner end so as to form a single piece;
the said body comprising an adapter seat intended to receive the bead (B) and situated near the axially outer end;
the said body comprising at least one main reinforcement providing the connection between the outer reinforcing element and the inner reinforcing element, the main reinforcement comprising at least one first and one second reinforcing ply which are placed radially relative to one another, the said reinforcing plies each comprising mutually parallel reinforcers coated in elastomer composition referred to as skim rubber;
a layer of elastomer composition in a colour other than black, also referred to as coloured rubber, positioned as desired:
in place of the skim rubber with which the reinforcers of each ply are coated, or
in place of the skim rubber with which the reinforcers are coated and placed only on the exterior periphery of the reinforcing plies, or
on the outside of the skim rubber.

The reference zone makes any premature damage or wear caused to the adapter quickly and easily visible. Furthermore, the reference zone is located in the immediate vicinity of the components that are of structural importance to the adapter. Thus, any superficial damage or damage which does not extend very deeply (namely the vast majority of damage caused by everyday knocks) does not uncover the reference zone. The user is therefore alerted only when the situation really is likely to require maintenance or repair intervention, or even a change of adapter.

According to one advantageous embodiment, the coloured rubber contains titanium oxide, kaolin, chalk or a mixture thereof.

According to another advantageous embodiment, the coloured rubber may contain TPE, such as SIS, SBS.

According to one exemplary embodiment, the coloured rubber is in the form of a layer covering a plurality of reinforcers.

As an alternative, the coloured rubber is in the form of an individual coating of each of the reinforcing cords.

According to another advantageous embodiment, the coloured rubber comprises a first colour in the form of a layer covering a plurality of reinforcing threads, and at least a second colour (C3), distinct from the first, in the form of an individual coating of each of the reinforcing threads. This embodiment makes it possible to obtain progressive levels of alert, according to the criticality of the damage. The three colours are advantageously easily distinguishable.

According to another advantageous embodiment, at least one reference zone is located on just a portion of the adapter. This arrangement makes it possible to target the reference zone or zones on those zones of the adapter which are subjected to kerbing and other very frequent types of knocks, or zones with greater levels of wear through scuffing against the kerb or through tyre/tyre-spreader wear.

For example, the reference zone is positioned at least in the region of contact between the adapter and the tyre. In this case, damage will be clearly visible when the tyre is changed and will demand action on the adapter, such as, for example, the replacement of same by a new adapter.

Advantageously, the reference zone is positioned at least in the region of the exterior surface of the adapter, particularly in the region of the outer reinforcer.

According to another alternative form of embodiment, the reference zone is positioned at least in the region of the adapter seat.

The invention also provides a mounted assembly comprising an adapter as described hereinabove.

### DESCRIPTION OF THE FIGURES

All the embodiment details are given in the description which follows, supplemented by FIGS. 1 to 4, which are given solely for the purposes of nonlimiting examples and in which:

FIG. 1 is a radial section through one example of an adapter mounted on a rolling assembly according to the invention;

FIG. 2 illustrates the adapter on its own in an enlarged view;

FIGS. 3A, 3B and 3C and 3D depict examples of adapters according to the invention;

FIG. 4 is a schematic depiction in cross section of a portion of another exemplary embodiment of an adapter according to the invention.

### DETAILED DESCRIPTION OF THE INVENTION

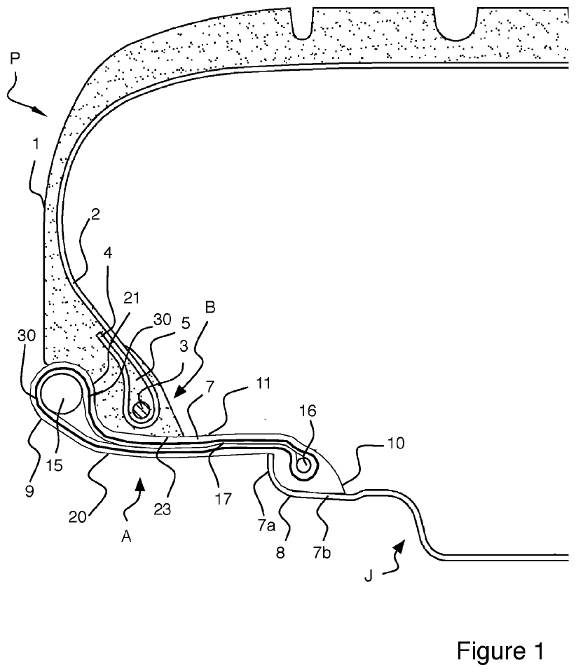

FIG. 1 shows a radial section, in a plane YZ, of a rolling assembly comprising a tyre P, a rim J, and, for each bead B, an adapter A providing the connection between the bead B and the rim J. The tyre P comprises a tread (unreferenced) extended radially towards the inside by two sidewalls 1, themselves extended radially towards the inside by two beads B. Within each bead B, the carcass reinforcement 2 is turned up around a circumferential reinforcing element or bead wire 3 to form a turnup 4 separated from the carcass reinforcement 2 by a filling element 5. The rim J comprises, in a middle portion, a mounting well, intended to make it easier to mount the beads B of the tyre P and, at its axial ends, two rim bead seats 8, each one comprising a substantially radial portion or rim flange 7a and a substantially axial portion or rim seat 7b. The adapter A comprises an axially inner end 10 comprising an inner reinforcing element 16 and intended to be mounted on a rim bead seat 8, an axially outer end 9 comprising an outer reinforcing element 15 and intended to come into contact via a substantially radial axially inner face, or bearing face 21, with a bead B, and finally a body 11, connecting the axially outer end 9 to the axially inner end 10 so as to form a single piece. The adapter also comprises at least one main reinforcement 17 providing the connection between the outer reinforcing element 15 and the inner reinforcing element 16, and a substantially axial adapter seat 23 intended to come into contact with a bead B.

The main reinforcement 17 comprises at least a first 18 and a second 19 reinforcing ply extending close to one another between the outer 15 and inner 16 reinforcing elements. These reinforcing plies 18 and 19 each comprise reinforcers 35 coated in elastomer composition referred to as skim rubber 31. More generally, the main reinforcement 17 of the adapter may be made of an orthotropic material having a main direction of maximum stiffness making an angle at least equal to 30° with the circumferential direction.

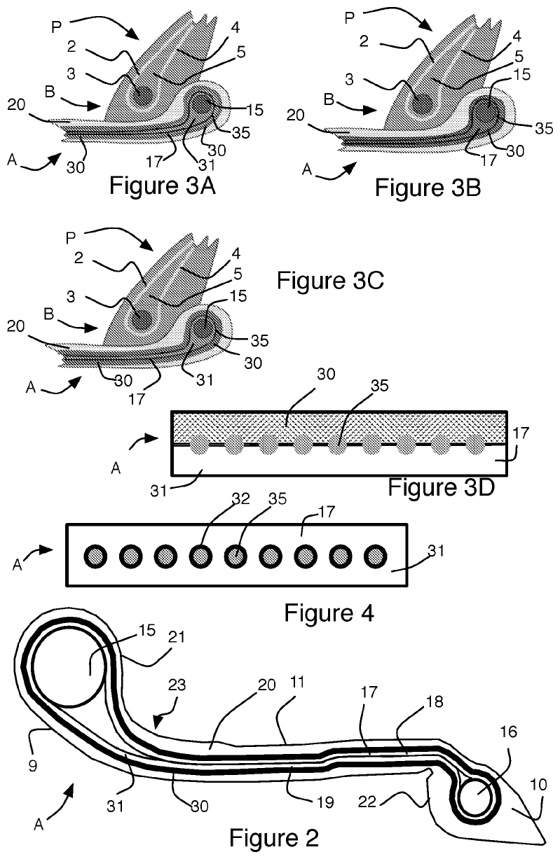

FIG. 2 depicts a radial section of an adapter according to the invention not mounted on a rolling assembly. This adapter comprises an axially outer end 9 comprising an outer reinforcing element 15, an axially inner end 10 comprising an inner reinforcing element 16, and a body 11 comprising a main reinforcement 17. The main reinforcement 17 is wound respectively around the inner reinforcing element 16 of the axially inner end 10 and around the outer reinforcing element 15 of the axially outer end 9. In the body 11, the main and return portions of the said reinforcing layer thus form a substantially radial stack of at least two reinforcing plies 18 and 19. According to various alternative forms of embodiment, the reinforcers in zone 17 are radial, or at an angle. For example, the angles of these reinforcers are preferably between +30° and −30° with respect to the longitudinal direction. The reinforcers are textile cords made of PET, polyamide, rayon, aramid.

The body 11 further comprises an adapter seat 23 which is intended to come into contact with a tyre bead. The body 11 has an axial width L (not illustrated), measured between the axially inner face 21 of the axially outer end 9 and the axially outer face 22 of the axially inner end 10.

The main reinforcement 17 is enveloped in a layer 30 of a colour other than black, made of elastomer material. This layer 30 is itself coated in an external layer 20 of elastomer material, preferably black. The coloured layer 30 forms a reference layer because of its colour which is distinct from the protective outer layers. The layer 30 may for example be red, or blue, or green, or yellow, or orange, or another colour easily visible to a user.

In another embodiment, the distinctiveness of the reference layer is obtained by inverting the colours so that the adapter comprises an outer layer 20 coloured red, or blue, or green, or yellow, or orange, or another colour easily visible to a user, and an inner reference layer 30 that is black, or a colour other than that of the outer layer 20.

FIG. 3A schematically illustrates one example of a radially outer portion of an adapter on which a tyre is arranged. The enlarged view in the figure makes it easy to see the interface between the two elements. Furthermore, the main reinforcement 17 comprising a plurality of substantially mutually parallel reinforcers 35 can be seen. This reinforcement is enveloped in a layer 30 of a colour other than black, which is itself covered with an outer layer 20, preferably black. In this embodiment, the layer 30 covers the skim rubber 31 of the reinforcement 17.

FIGS. 3B and 3C illustrate alternative forms of embodiment with respect to the arrangement of FIG. 3A. In the arrangement of FIG. 3B, the reinforcement 17 and the coloured layer 30 form just one and the same single element, the distinctive colour characteristics described hereinabove in connection with the reference layer 30 are incorporated into the reinforcement 17, the coloured layer being arranged in place of the skim rubber 31 coating the reinforcers 35 of the plies 18 and 19. In other words, in this embodiment, the coloured layer 30 acts as skim rubber.

In the arrangement of FIG. 3C, the coloured layer 30 replaces the skim rubber only on the exterior periphery of the reinforcing plies 18 and 19. This embodiment is also illustrated in cross section in FIG. 3D.

FIG. 4 illustrates another alternative form of embodiment in which the reinforcers 35 of the reinforcement 17 are each coated in an individual coating 32 of a colour other than black. This embodiment, which forms multiple highly localized reference zones (as many zones as there are reinforcing threads), makes it possible to pinpoint the damage revealed. Furthermore, this approach makes it possible to avoid untimely alerts brought about by superficial damage.

When the reference zone 30 or 32 is incorporated into a black adapter, it is made in a shade distinct from black, so as to be clearly visible when exposed to the open air following damage to the external layer 20. As an alternative, the external layer 20 is made from a shaded (other than black) elastomer composition and the reference zone (layer 30 or coating 32) is in another colour, or in black.

Another embodiment provides for a double reference zone. In this embodiment, a coloured layer 30 as described hereinabove in connection with FIGS. 3A, 3B and 3C is provided in a first colour. At least one second reference zone, made up of individual coatings 32 as described hereinabove in connection with FIG. 4, is also provided, in a second colour distinct from the first. This hybrid embodiment makes it possible to generate two levels of alert or warning. A first level of alert is given when damage uncovers a portion of the coloured layer 30. A second, more critical, level of alert is given when damage uncovers one or more individual coatings 32. This embodiment is particularly suited to adapters intended for use in harsh or aggressive environments and makes it possible accurately to know the true condition of the adapter and take the required actions at the appropriate moment.

As an alternative to the various embodiments described hereinabove, the reference zone is situated on just a portion of the adapter. For example, a reference zone is advantageously provided in the zone intended to be visible from the outside of the vehicle once the adapter and the tyre have been fitted. Effectively, it is in this zone and, more particularly, in the axially outer zone, that the risks of damage are the greatest. This alternative form can be implemented in connection with one or more reference layers 30 as described hereinabove, or in connection with coatings 32 as described in connection with FIG. 4, or in connection with the hybrid mode that involves both one or more layers 30, and coatings 32, in distinct colours, as described hereinabove.

### REFERENCE NUMERALS EMPLOYED IN THE FIGURES

A Adapter
B Bead
J Rim
P Tyre
1 Sidewall
2 Carcass
3 Bead wire
4 Turnup
5 Filling element
7a Rim flange
7b Rim seat
8 Rim bead seat
9 Adapter axially outer end
10 Adapter axially inner end
11 Adapter body
15 Outer reinforcing element
16 Inner reinforcing element
17 Main reinforcement
18 Main reinforcement first ply
19 Main reinforcement second ply
20 External layer
21 Bearing face
22 Axially outer face
23 Adapter seat
30 Coloured layer of a colour other than black
31 Skim rubber
32 Individual coating in a colour other than black
35 Substantially parallel reinforcers

1.-11. (canceled)

12. An adapter for a rolling assembly, the rolling assembly having an axis of rotation and comprising a tire having two beads, a rim having two rim bead seats, and the adapter providing the connection between one of the beads and the rim, and the adapter comprising:
an axially inner end configured to be mounted on a rim bead seat and comprising an inner reinforcing element and a substantially radial axially outer face;
an axially outer end configured to come into contact with a bead and comprising an outer reinforcing element and a substantially radial axially inner bearing face; and
a substantially axial body connecting the axially outer end to the axially inner end so as to form a single piece, the body comprising an adapter seat configured to receive the bead and situated near the axially outer end and the body comprising at least one main reinforcement providing the connection between the outer reinforcing element and the inner reinforcing element, the main reinforcement comprising at least one first and one second reinforcing ply which are placed radially relative to one another, each reinforcing ply comprising mutually parallel reinforcers coated in a skim rubber comprising an elastomer composition,
wherein a layer of elastomer composition is positioned (1) in place of the skim rubber with which the reinforcers of each ply are coated, (2) in place of the skim rubber with which the reinforcers are coated and placed only on an exterior periphery of the first and second reinforcing plies, or (3) on the outside of the skim rubber, and
wherein the layer of elastomer is a colored rubber, the colored rubber being a color other than black.

13. The adapter according to claim 12, wherein the colored rubber contains titanium oxide, kaolin, chalk or a mixture thereof.

14. The adapter according to claim 12, wherein the colored rubber contains TPE.

15. The adapter according to claim 14, wherein the TPE is selected from the group consisting of SIS and SBS.

16. The adapter according to claim 12, wherein the colored rubber is in the form of a layer covering a plurality of reinforcers.

17. The adapter according to claim 12, wherein the colored rubber is in the form of an individual coating of each of the reinforcers.

18. The adapter according to claim 12, wherein the colored rubber comprises a first color in the form of a layer covering a plurality of reinforcers and at least a second color, distinct from the first color, in the form of an individual coating of each of the reinforcers.

19. The adapter according to claim 12, wherein the colored rubber is located on only a portion of the adapter.

20. The adapter according to claim 12, wherein the colored rubber is positioned at least in a region of the adapter seat.

21. The adapter according to claim 12, wherein the colored rubber is positioned at least in a region of contact between the adapter and the tire.

22. A mounted assembly comprising an adapter according to claim 12.
